(19) United States
(12) Patent Application Publication
(10) Pub. No.: US 2006/0174773 A1
(43) Pub. Date: Aug. 10, 2006

(54) Dispensing system with vacuum-filled metering chamber

(75) Inventor: Jon Taylor, Groton, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Keurig Incorporated, Wakefield, MA (US)

(21) Appl. No.: 11/393,615

(22) Filed: Mar. 30, 2006

Related U.S. Application Data
(63) Continuation of application No. 10/790,533, filed on Mar. 1, 2004.

(51) Int. Cl. A47J 31/00

(52) U.S. Cl. 99/280; 99/279

(57) ABSTRACT

A system for dispensing a metered volume of heated water from the storage tank to the brew chamber of a single serve beverage brewer comprises a metering chamber, a supply conduit connecting the storage tank to the metering chamber, and a delivery conduit connecting the metering chamber to the brew chamber. An air pump coacts with associated valves to alternately withdraw heated water from the storage tank into the metering chamber via the supply conduit, and to expel heated water from the metering chamber via the delivery conduit to the brew chamber.

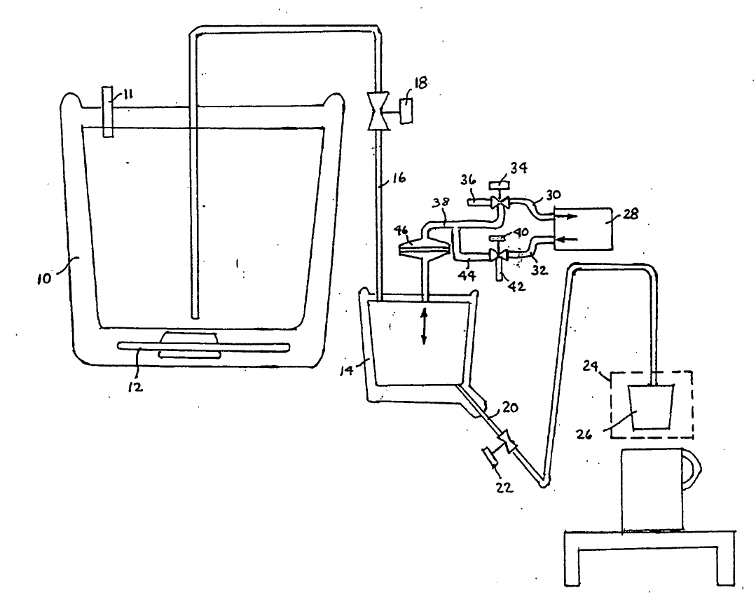

### CROSS REFERENCE TO RELATED APPLICATIONS

This application is a continuation application of prior U.S. application Ser. No. 10/790,533, filed Mar. 1, 2004.

### BACKGROUND OF THE INVENTION

1. Field of the Invention

This invention relates generally to single serve beverage brewers, and is concerned in particular with an improved system for repeatedly dispensing the metered amounts of heated water required to effect successive brew cycles.

2. Description of the Prior Art

Known water dispensing systems for single serve beverage dispensers commonly employ buoyant and/or mechanically activated metering components. Such systems are relatively complex and expensive, and are prone to developing sealing problems due to a build up of mineral deposits at critical interfaces.

The objective of the present invention is to provide an improved air-activated system that avoids or at least significantly minimizes the above-mentioned shortcomings.

### SUMMARY OF THE INVENTION

In accordance with the present invention, a system for dispensing a metered volume of heated water from the storage tank to the brew chamber of a single serve beverage brewer comprises a metering chamber, a supply conduit connecting the storage tank to the metering chamber, and a delivery conduit connecting the metering chamber to the brew chamber. An air pump coacts with associated valves to alternately withdraw heated water from the storage tank into the metering chamber via the supply conduit, and to expel heated water from the metering chamber via the delivery conduit to the brew chamber.

These and other features and advantages of the present invention will now be described in greater detail with reference to the accompanying drawing, wherein:

### BRIEF DESCRIPTION OF THE DRAWING

The single FIGURE is a schematic illustration of a system in accordance with the present invention.

### DETAILED DESCRIPTION OF THE PREFERRED EMBODIMENT

With reference to the accompanying drawing, a storage tank 10 contains a supply of water heated to an appropriate elevated temperature by a heater 12. The storage tank is vented to atmosphere at 11.

A metering chamber 14 is connected to the storage tank 10 by a supply conduit 16 which includes a first valve 18. The metering chamber 14 is also connected via a delivery conduit 20 and a second valve 22 to a brew chamber 24 adapted to receive a single serve beverage filter cartridge 26 of the type described, for example, in U.S. Pat. No. 5,840,189 (Sylvan et al.) and U.S. Pat. No. 5,325,765 (Sylvan et al.).

An air pump 28 has suction and discharge conduits 30, 32. A third valve 34 is adjustable to alternately connect suction conduit 30 to atmosphere via a vent 36 or to a conduit 38 communicating with the metering chamber 14. A fourth valve 40 is similarly adjustable to alternately connect discharge conduit 32 to atmosphere via a vent 42 or to a branch conduit 44 leading to conduit 38.

At the onset of a brew cycle, valve 22 is closed and valve 18 is opened. Valve 34 is set to connect the pump suction conduit 30 to the metering chamber 14 via conduit 38, and valve 40 is set to connect the pump discharge conduit 32 to the vent 42. The pump 28 thus operates to create a vacuum in the metering chamber 14, resulting in hot water being drawn into the metering chamber 14 from tank 10 via conduit 16.

When the metering chamber has been charged with the appropriate volume of hot water (a determination based either on a timed cycle or on a sensing of the water level in the metering chamber), valve 18 is closed, valve 22 is opened, and the settings of valves 34 and 40 are reversed. Thus, the air pump 28 now delivers pressurized air to the metering chamber via conduits 32, 44 and 38 while the pump suction line 30 communicates with the vent 36. The air being forced into the metering chamber causes water to be expelled therefrom via conduit 20 to the brew chamber 24. The brew chamber also may be of the type described in the above referenced U.S. patents, the disclosures of which are herein incorporated by reference.

Conduit 38 may be provided with one a way barrier component 46 such as a filter, condenser or the like to safeguard the air pump 28 against ingestion of water vapor or water drawn from the metering cup.

1. A beverage forming system comprising:
a storage tank adapted to hold liquid used in forming at least one beverage;
a metering chamber in fluid communication with the storage tank and adapted to receive a volume of liquid from the storage tank;
a brew chamber in fluid communication with the metering chamber and adapted to receive a metered volume of liquid from the metering chamber for use in forming the at least one beverage; and
a liquid supply system adapted to cause flow of liquid from the storage tank to the metering chamber, the liquid supply system being controllable to effect partial fill of the metering chamber.

2. The system of claim 1, wherein the liquid supply system includes a fluid pump that causes flow of liquid from the storage tank to the metering chamber.

3. The system of claim 1, wherein the metering chamber is physically separated from the storage tank and fluidly communicates with the storage tank via a conduit.

4. The system of claim 1, further comprising a sensor adapted to sense a liquid level in the metering chamber.

5. The system of claim 4, wherein information regarding the liquid level sensed by the sensor is used to control the liquid supply system.

6. The system of claim 1, wherein the liquid supply system is adapted to cause flow of liquid from the storage tank to the metering chamber for a predetermined period of time so as to effect partial fill of the metering chamber.

7. The system of claim 1, further comprising a heater that heats water provided to the brew chamber.

8. The system of claim 1, wherein the liquid supply system is adapted to cause flow of liquid from the metering chamber to the brew chamber.

9. The system of claim 8, wherein the liquid supply system includes an air pump that delivers pressurized air to the metering chamber to cause flow of the liquid from the metering chamber to the brew chamber.

10. The system of claim 1, further comprising a vent that is openable to allow liquid to flow into the metering chamber.

11. The system of claim 1, wherein liquid provided from the metering chamber to the brew chamber is heated.

12. The system of claim 1, wherein the brew chamber is adapted to receive a disposable beverage cartridge, and is adapted to pierce the disposable beverage cartridge and introduce liquid from the metering chamber into the beverage cartridge.

13. The system of claim 12, wherein the disposable beverage cartridge includes a beverage medium contained within a filter element, and liquid introduced into the disposable beverage cartridge contacts the beverage medium and passes through the filter element to form the at least one beverage.

14. The system of claim 13, wherein the beverage medium includes roasted ground coffee.

15. A beverage forming system comprising:
a storage tank adapted to hold liquid used in forming at least one beverage;
a metering chamber in fluid communication with the storage tank and adapted to receive a volume of liquid from the storage tank;
a brew chamber in fluid communication with the metering chamber and adapted to receive a metered volume of liquid from the metering chamber for use in forming the at least one beverage; and
a liquid supply system adapted to cause flow of liquid from the storage tank to the metering chamber, the liquid supply system including a sensor to detect a liquid level in the metering chamber.

16. he system of claim 15, wherein the liquid supply system includes a fluid pump that causes flow of liquid from the storage tank to the metering chamber.

17. The system of claim 15, wherein the metering chamber is physically separated from the storage tank and fluidly communicates with the storage tank via a conduit.

18. The system of claim 15, wherein the liquid level sensed by the sensor is used to control the metered volume of liquid provided to the brew chamber.

19. The system of claim 15, wherein information regarding the liquid level sensed by the sensor is used to control the liquid supply system.

20. The system of claim 15, wherein the liquid supply system is adapted to cause flow of liquid from the storage tank to the metering chamber for a predetermined period of time so as to effect partial fill of the metering chamber.

21. The system of claim 15, further comprising a heater that heats water provided to the brew chamber.

22. The system of claim 15, wherein the liquid supply system is adapted to cause flow of liquid from the metering chamber to the brew chamber.

23. The system of claim 22, wherein the liquid supply system includes an air pump that delivers pressurized air to the metering chamber to cause flow of the liquid from the metering chamber to the brew chamber.

24. The system of claim 15, further comprising a vent that is openable to allow liquid to flow into the metering chamber.

25. The system of claim 15, wherein liquid provided from the metering chamber to the brew chamber is heated.

26. The system of claim 15, wherein the brew chamber is adapted to receive a disposable beverage cartridge, and is adapted to pierce the disposable beverage cartridge and introduce liquid from the metering chamber into the beverage cartridge.

27. The system of claim 26, wherein the disposable beverage cartridge includes a beverage medium contained within a filter element, and liquid introduced into the disposable beverage cartridge contacts the beverage medium and passes through the filter element to form the at least one beverage.

28. The system of claim 27, wherein the beverage medium includes roasted ground coffee.

29. The system of claim 15, wherein the liquid supply system is adapted to cause flow of liquid from the storage tank to the metering chamber so as to effect partial fill of the metering chamber.

30. A beverage forming system comprising:
a storage tank adapted to hold liquid used in forming at least one beverage;
a metering chamber in fluid communication with the storage tank and adapted to receive a volume of liquid from the storage tank;
a brew chamber in fluid communication with the metering chamber and adapted to receive a metered volume of liquid from the metering chamber for use in forming the at least one beverage; and
a liquid supply system adapted to cause flow of liquid from the storage tank to the metering chamber for a specified period of time to provide the metering chamber with a specified volume of liquid.

31. The system of claim 30, wherein the liquid supply system includes a fluid pump that causes flow of liquid from the storage tank to the metering chamber.

32. The system of claim 30, wherein the metering chamber is physically separated from the storage tank and fluidly communicates with the storage tank via a conduit.

33. The system of claim 30, further comprising a sensor adapted to sense a liquid level in the metering chamber.

34. The system of claim 33, wherein information regarding the liquid level sensed by the sensor is used to control the liquid supply system.

35. The system of claim 30, wherein the liquid supply system is adapted to cause flow of liquid from the storage tank to the metering chamber for a predetermined period of time so as to effect partial fill of the metering chamber.

36. The system of claim 30, further comprising a heater that heats water provided to the brew chamber.

37. The system of claim 30, wherein the liquid supply system is adapted to cause flow of liquid from the metering chamber to the brew chamber.

38. The system of claim 37, wherein the liquid supply system includes an air pump that delivers pressurized air to the metering chamber to cause flow of the liquid from the metering chamber to the brew chamber.

39. The system of claim 30, further comprising a vent that is openable to allow liquid to flow into the metering chamber.

40. The system of claim 30, wherein liquid provided from the metering chamber to the brew chamber is heated.

41. The system of claim 30, wherein the brew chamber is adapted to receive a disposable beverage cartridge, and is adapted to pierce the disposable beverage cartridge and introduce liquid from the metering chamber into the beverage cartridge.

42. The system of claim 41, wherein the disposable beverage cartridge includes a beverage medium contained within a filter element, and liquid introduced into the disposable beverage cartridge contacts the beverage medium and passes through the filter element to form the at least one beverage.

43. The system of claim 42, wherein the beverage medium includes roasted ground coffee.

44. The system of claim 30, wherein the liquid supply system is adapted to cause flow of liquid from the storage tank to the metering chamber so as to effect partial fill of the metering chamber.
